(19) United States
(12) Patent Application Publication
(10) Pub. No.: US 2026/0154609 A1
(43) Pub. Date: Jun. 4, 2026

(54) ATTRIBUTE SELECTION FOR EXAMINATION OF SEMICONDUCTOR SPECIMENS

(71) Applicant: Applied Materials Israel Ltd., Rehovot (IL)

(72) Inventors: Asaf NISANI, Ashkelon (IL); Hila KOHANE BERKOVICH, Ness Ziona (IL); Boris SHERMAN, Rehovot (IL)

(21) Appl. No.: 18/966,021

(22) Filed: Dec. 2, 2024

(51) Int. Cl. G06N 20/00

(52) U.S. Cl. CPC G06N 20/00

(57) ABSTRACT

There is provided a system and method of attribute selection. The method includes obtaining a first dataset comprising defect candidates, each characterized by a set of attributes and associated with a ground truth label thereof; training a machine learning (ML) model using the first dataset, and estimating, for each attribute, a first significance value based on the trained ML model; generating one or more second datasets based on the first dataset, each second dataset comprising the defect candidates each associated with a synthetic label; retraining the ML model respectively using the one or more second datasets, and estimating, for each attribute, one or more second significance values based on one or more respectively retrained ML models; calculating a normalized significance value for each attribute based on the first significance value and the second significance values; and selecting a subset of attributes based on their normalized significance values.

### TECHNICAL FIELD

The presently disclosed subject matter relates, in general, to the field of examination of a semiconductor specimen, and more specifically, to attribute selection usable for machine-learning based examination.

### BACKGROUND

Current demands for high density and performance associated with ultra large-scale integration of fabricated devices require submicron features, increased transistor and circuit speeds, and improved reliability. As semiconductor processes progress, pattern dimensions such as line width, and other types of critical dimensions, are continuously shrunken. Such demands require formation of device features with high precision and uniformity, which, in turn, necessitates careful monitoring of the fabrication process, including automated examination of the devices while they are still in the form of semiconductor wafers.

Examination can be provided by using non-destructive examination tools during or after manufacture of the specimen to be examined. A variety of non-destructive examination tools includes, by way of non-limiting example, scanning electron microscopes, atomic force microscopes, optical inspection tools, etc.

Examination processes can include a plurality of examination steps. The manufacturing process of a semiconductor device can include various procedures such as etching, depositing, planarization, growth such as epitaxial growth, implantation, etc. The examination steps can be performed a multiplicity of times, for example after certain process procedures, and/or after the manufacturing of certain layers, or the like. Additionally, or alternatively, each examination step can be repeated multiple times, for example for different wafer locations, or for the same wafer locations with different examination settings.

Examination processes are used at various steps during semiconductor fabrication to detect and classify defects on specimens, as well as perform metrology related operations. Effectiveness of examination can be improved by automatization of process(es) such as, for example, defect detection, Automatic Defect Classification (ADC), Automatic Defect Review (ADR), image segmentation, automated metrology-related operations, etc.

Automated examination systems ensure that the parts manufactured meet the quality standards expected and provide useful information on adjustments that may be needed to the manufacturing tools, equipment, and/or compositions, depending on the type of defects identified. In some cases, machine learning technologies can be used to assist the automated examination process so as to promote higher yield.

### SUMMARY

In accordance with certain aspects of the presently disclosed subject matter, there is provided a computerized system of attribute selection, the system comprising a processing circuitry configured to obtain a first dataset comprising a group of defect candidates resulting from examining a semiconductor specimen, each defect candidate characterized by a set of attributes and associated with a respective ground truth (GT) label indicative of a class thereof; train a machine learning (ML) model using the first dataset, and estimate, for each attribute in the set of attributes, a first significance value based on the trained ML model, wherein the first significance value is indicative of a level of relevance of the attribute in contributing to correct classification of the group of defect candidates; generate one or more second datasets based on the first dataset, wherein each second dataset comprises the group of defect candidates, each defect candidate associated with a synthetic label assigned to disrupt correlation between the defect candidate and the respective GT label thereof; retrain the ML model respectively using the one or more second datasets, and estimate, for each attribute, one or more second significance values based on one or more respectively retrained ML models; calculate a normalized significance value for each attribute based on the first significance value and the one or more second significance values of the attribute; and select a subset of attributes from the set of attributes based on their respective normalized significance values.

In addition to the above features, the system according to this aspect of the presently disclosed subject matter can comprise one or more of features (i) to (ix) listed below, in any desired combination or permutation which is technically possible:
(i). The processing circuitry can be configured to train the ML model by: for each given defect candidate in the group, processing the given defect candidate by the ML model, to obtain a predicted class thereof, and optimizing the ML model using a loss function based on the predicted class and the GT label associated with the given defect candidate, and wherein the first significance value for each attribute is estimated based on a function or a rule of the trained ML model.
(ii). The synthetic label for each defect candidate in a second dataset can be randomly assigned in accordance with a probability predefined based on the number of classes of the defect candidates present in the first dataset, so as to result in substantially equivalent distribution of defect candidates associated with each synthetic label in the second dataset.
(iii). The normalized significance value for each given attribute can be calculated based on a ratio of the number of second significance values that exceed the first significance value for the given attribute, to a total number of the second significance values.
(iv). The processing circuitry can be further configured to, prior to generating the one or more second datasets: select a plurality of top-ranking attributes from the set of attributes based on the first significance values thereof, and perform the subsequent steps of generating, retraining, calculating and selecting, with respect to the plurality of top-ranking attributes in place of the set of attributes.
(v). The normalized significance value of a given attribute represents statistical importance of the given attribute, with reduced bias compared to the first significance value of the given attribute.
(vi). The set of attributes can comprise one or more hand-crafted attributes from a group comprising: grade, volume, polarity, strength, size, location and probability of the defect candidate being a DOI.
(vii). The set of attributes can comprise one or more abstract attributes extracted from a neural network used to pre-process the group of defect candidates.
(viii). The selected subset of attributes can be usable for characterizing a training set of defect candidates usable for training a classifier for defect classification.
(ix). The selected subset of attributes can be usable for clustering or ranking of defect candidates.

In accordance with other aspects of the presently disclosed subject matter, there is provided a computerized method of attribute selection, the method comprising: obtaining a first dataset comprising a group of defect candidates resulting from examining a semiconductor specimen, each defect candidate characterized by a set of attributes and associated with a respective ground truth (GT) label indicative of a class thereof; training a machine learning (ML) model using the first dataset, and estimating, for each attribute in the set of attributes, a first significance value based on the trained ML model, wherein the first significance value is indicative of a level of relevance of the attribute in contributing to correct classification of the group of defect candidates; generating one or more second datasets based on the first dataset, wherein each second dataset comprises the group of defect candidates, each defect candidate associated with a synthetic label assigned to disrupt correlation between the defect candidate and the respective GT label thereof; retraining the ML model respectively using the one or more second datasets, and estimating, for each attribute, one or more second significance values based on one or more respectively retrained ML models; calculating a normalized significance value for each attribute based on the first significance value and the one or more second significance values of the attribute; and selecting a subset of attributes from the set of attributes based on their respective normalized significance values.

These aspects of the disclosed subject matter can comprise one or more of features (i) to (ix) listed above with respect to the system, mutatis mutandis, in any desired combination or permutation which is technically possible.

In accordance with other aspects of the presently disclosed subject matter, there is provided a non-transitory computer readable medium comprising instructions that, when executed by a computer, cause the computer to perform a method of attribute selection, the method comprising: obtaining a first dataset comprising a group of defect candidates resulting from examining a semiconductor specimen, each defect candidate characterized by a set of attributes and associated with a respective ground truth (GT) label indicative of a class thereof; training a machine learning (ML) model using the first dataset, and estimating, for each attribute in the set of attributes, a first significance value based on the trained ML model, wherein the first significance value is indicative of a level of relevance of the attribute in contributing to correct classification of the group of defect candidates; generating one or more second datasets based on the first dataset, wherein each second dataset comprises the group of defect candidates, each defect candidate associated with a synthetic label assigned to disrupt correlation between the defect candidate and the respective GT label thereof; retraining the ML model respectively using the one or more second datasets, and estimating, for each attribute, one or more second significance values based on one or more respectively retrained ML models; calculating a normalized significance value for each attribute based on the first significance value and the one or more second significance values of the attribute; and selecting a subset of attributes from the set of attributes based on their respective normalized significance values.

This aspect of the disclosed subject matter can comprise one or more of features (i) to (xi) listed above with respect to the system, mutatis mutandis, in any desired combination or permutation which is technically possible.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2 illustrates a generalized flowchart of automatic attribute selection in accordance with certain embodiments of the presently disclosed subject matter.

FIG. 3 and FIG. 4 illustrate generalized flowcharts exemplifying implementation details of certain operations with respect to FIG. 2 in accordance with certain embodiments of the presently disclosed subject matter.

FIG. 5 shows an exemplary illustration of the first significance value and the distribution of the second significance values of a given attribute in accordance with certain embodiments of the presently disclosed subject matter.

FIG. 6 shows a schematic illustration of an example of a first dataset and a second dataset in accordance with certain embodiments of the presently disclosed subject matter.

FIG. 7 shows a schematic illustration of a training process of the ML model in accordance with certain embodiments of the presently disclosed subject matter.

### DETAILED DESCRIPTION OF EMBODIMENTS

The process of semiconductor manufacturing often requires multiple sequential processing steps and/or layers, some of which could possibly cause errors that may lead to yield loss. Examples of various processing steps can include lithography, etching, depositing, planarization, growth (such as, e.g., epitaxial growth), and implantation, etc. Various examination operations, such as defect-related examination (e.g., defect detection, defect review, and defect classification, etc.), and/or metrology-related examination (e.g., critical dimension (CD) measurements, etc.), can be performed at different processing steps/layers during the manufacturing process to monitor and control the process. The examination operations can be performed a multiplicity of times, for example after certain processing steps, and/or after the manufacturing of certain layers, or the like.

In some cases, machine learning (ML) technologies can be used to assist the defect examination process so as to provide accurate and efficient solutions for automating specific examination applications and promoting higher yield. For the purpose of providing a well-trained, accurate ML model that is robust with respect to various variations in actual production, training data must be sufficient in terms of quantity, quality and variance, etc. Oftentimes a training set of defect candidates can be derived from examining one or more semiconductor specimens which share the same design as the specimens to be examined in runtime. Each defect candidate in the training set is characterized by a set of attributes.

Typically, defect candidates in a semiconductor specimen are characterized by a wide range of attributes derived from examination data. These attributes can span various dimensions, including spatial attributes (e.g., defect location), intensity attributes (e.g., contrast or gray level intensities), and other operational parameters (e.g., acquisition time, acquisition tool ID). This extensive set of attributes, while valuable in capturing various aspects of the defect candidates, may introduce high-dimensional data that can present challenges when used directly in machine learning (ML) model training.

To address these challenges, it is sometimes beneficial to select a subset of attributes that are more significant in terms of their contribution to the accurate classification of defect candidates. By identifying and focusing on a subset of critical attributes, it is possible to reduce the dimensionality of the training data, which can improve the model's efficiency and performance. For instance, certain attributes may provide minimal or redundant information that does not significantly impact the classification accuracy of the ML model. In contrast, other attributes may offer high discriminatory power, making them more valuable for distinguishing between different defect types or for identifying true defects.

In addition, a reduced attribute set can lead to shorter training times for training a ML model, as the ML model has fewer dimensions to process and analyze. This can also reduce the computational resources needed to train the model, which can be particularly advantageous when working with large datasets or when deploying the model in real-time applications. Furthermore, focusing on more relevant attributes can enhance the model's ability to generalize across various production scenarios, improving the robustness of defect classification, even when production conditions or specimen characteristics vary.

Despite the advantages of attribute selection in reducing dimensionality and enhancing model performance, existing methods for attribute selection can present notable challenges and limitations. By way of example, it has been observed that attribute selection processes may be biased, particularly in cases where attributes with a larger number of categorical or value options tend to be favored over those with fewer options. This bias can lead to an overestimation of the importance of certain attributes, potentially skewing the selection process and impacting the efficacy of the ML model.

For instance, an attribute like gray level intensity, which may have up to 255 possible values, could be preferentially selected over a binary attribute with only two options, such as a true/false class indicator. The higher number of categories or value options in attributes like gray level intensity may give the appearance of greater significance simply due to the variety of possible values, leading selection algorithms to incorrectly assume it is more informative for defect classification.

Another issue in attribute selection is the difficulty in determining the optimal number of attributes to retain. Since there is no universally applicable threshold for how many top-ranking attributes should be selected, it is often unclear where to draw the line in deciding which attributes are indeed valuable for model training. Selecting too few attributes may result in the omission of important information, potentially reducing the accuracy of defect classification. Conversely, retaining too many attributes can reintroduce the problems of high-dimensionality, increased computational load, and the risk of overfitting, thereby counteracting the intended benefits of attribute selection.

These biases and challenges in attribute selection can have significant implications for the machine learning model's performance and reliability. If biased attribute selection results in the model prioritizing attributes that are not truly indicative of defect characteristics, the model may fail to generalize well across varied specimens or manufacturing scenarios, leading to decreased defect detection accuracy. Furthermore, when selection algorithms favor attributes with larger category options, critical but subtle attributes might be overlooked, reducing the model's sensitivity to certain types of defects. This can ultimately impact yield rates, as undetected or misclassified defects might lead to unaddressed manufacturing issues.

Accordingly, certain embodiments of the presently disclosed subject matter propose an automated system for attribute selection, which does not have one or more of the disadvantages described above. In certain embodiments of the present disclosure, a set of candidate defect attributes can be evaluated based on a significance measure calculated through both informative settings (where ground truth labels correlate with defect attributes) and non-informative settings (where synthetic labels are assigned to break this correlation). By generating multiple non-informative datasets with balanced synthetic label distributions and comparing the attribute significance values across these settings, the system calculates a normalized significance value for each attribute, thus identifying those that contribute most meaningfully to defect classification. This automated, bias-reduced selection method ensures that only the most impactful attributes are retained, enhancing the model's performance and generalization capabilities, as will be detailed below.

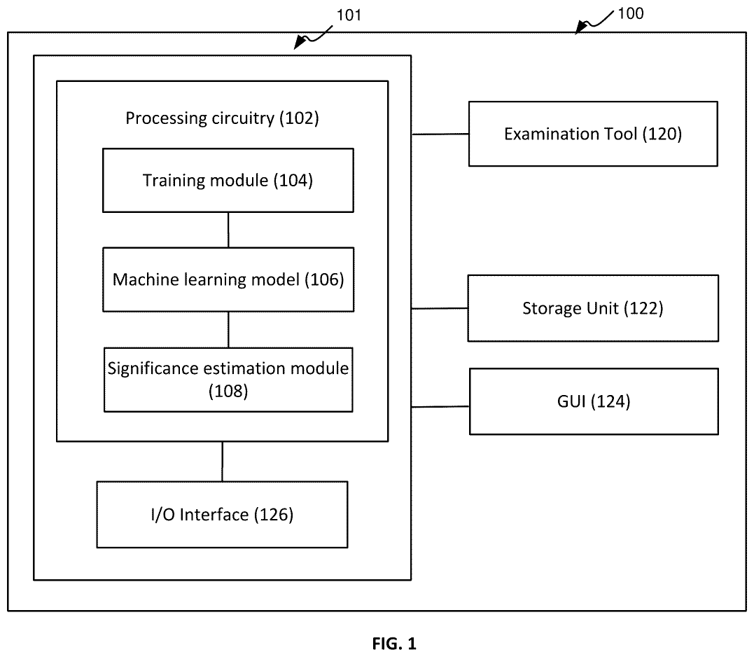

Bearing this in mind, attention is drawn to FIG. 1 illustrating a functional block diagram of an examination system in accordance with certain embodiments of the presently disclosed subject matter.

The examination system 100 illustrated in FIG. 1 can be used for examination of a semiconductor specimen (e.g., a wafer, a die, or parts thereof) as part of the specimen fabrication process. As described above, the examination referred to herein can be construed to cover any kind of operations related to defect inspection/detection, defect review, defect classification, nuisance filtration, segmentation, and/or metrology operations, etc., with respect to the specimen. System 100 comprises one or more examination tools 120 configured to scan a specimen and capture images thereof to be further processed for various examination applications.

The term “examination tool(s)” used herein should be expansively construed to cover any tools that can be used in examination-related processes, including, by way of non-limiting example, scanning (in a single or in multiple scans), imaging, sampling, reviewing, measuring, classifying, and/or other processes provided with regard to the specimen or parts thereof. Without limiting the scope of the disclosure in any way, it should also be noted that the examination tools can be implemented as inspection machines of various types, such as optical inspection machines, electron beam inspection machines (e.g., a Scanning Electron Microscope (SEM), an Atomic Force Microscopy (AFM), or a Transmission Electron Microscope (TEM), etc.), and so on.

The one or more examination tools 120 can include one or more inspection tools and one or more review tools. In some cases, an inspection tool can be configured to scan a specimen (e.g., an entire wafer, an entire die, or portions thereof) to capture inspection images (typically, at a relatively high-speed and/or low-resolution) for detection of potential defects (i.e., defect candidates). During inspection, the wafer can move at a step size relative to the detector of the inspection tool (or the wafer and the tool can move in opposite directions relative to each other) during the exposure, and the wafer can be scanned step-by-step along swaths of the wafer by the inspection tool, where the inspection tool images a part/portion (within a swath) of the specimen at a time. By way of example, the inspection tool can be an optical inspection tool. At each step, light can be detected from a rectangular portion of the wafer, and such detected light is converted into multiple intensity values at multiple points in the portion, thereby forming an image corresponding to the part/portion of the wafer. For instance, in optical inspection, an array of parallel laser beams can scan the surface of a wafer along the swaths. The swaths are laid down in parallel rows/columns contiguous to one another, to build up, swath-at-a-time, an image of the surface of the wafer. For instance, the tool can scan a wafer along a swath from up to down, then switch to the next swath and scan it from down to up, and so on and so forth, until the entire wafer is scanned and inspection images of the wafer are collected.

In some cases, a review tool can be configured to capture review images of at least some of the defect candidates detected by inspection tools for ascertaining whether a defect candidate is indeed a defect of interest (DOI). Such a review tool is usually configured to inspect fragments of a specimen, one at a time (typically, at a relatively low-speed and/or high-resolution). By way of example, the review tool can be an electron beam tool, such as, e.g., a scanning electron microscope (SEM), etc. An SEM is a type of electron microscope that produces images of a specimen by scanning the specimen with a focused beam of electrons. The electrons interact with atoms in the specimen, producing various signals that contain information on the surface topography and/or composition of the specimen. An SEM is capable of accurately inspecting and measuring features during the manufacture of semiconductor wafers.

The inspection tool and review tool can be different tools located at the same or at different locations, or a single tool operated in two different modes. In some cases, the same examination tool can provide low-resolution image data and high-resolution image data. The resulting image data (low-resolution image data and/or high-resolution image data) can be transmitted—directly or via one or more intermediate systems—to system 101. The present disclosure is not limited to any specific type of examination tools and/or the resolution of image data resulting from the examination tools. In some cases, at least one of the examination tools has metrology capabilities and can be configured to capture images and perform metrology operations on the captured images. Such an examination tool is also referred to as a metrology tool.

According to certain embodiments of the presently disclosed subject matter, the examination system 100 comprises a computer-based system 101 operatively connected to the examination tool 120, and capable of automatic attribute selection for ML-based examination of semiconductor specimens. System 101 is also referred to as an attribute selection system.

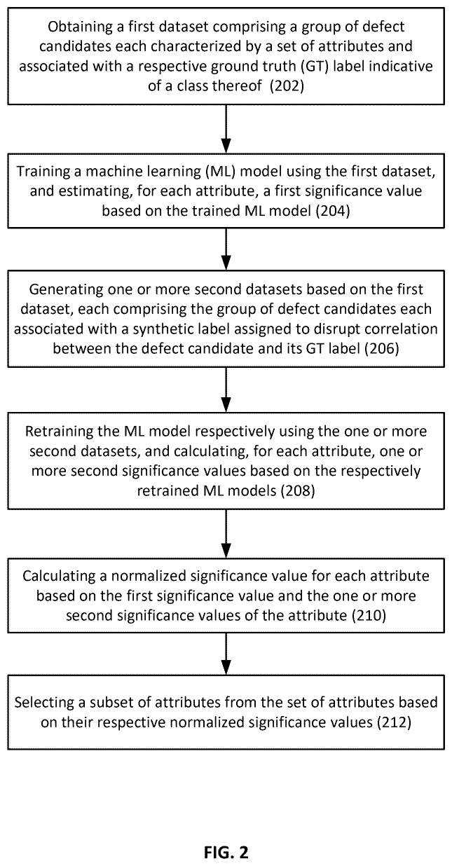

System 101 includes a processing circuitry 102 operatively connected to a hardware-based I/O interface 126 and configured to provide processing necessary for operating the system, as further detailed with reference to FIGS. 2-4. The processing circuitry 102 can comprise one or more processors (not shown separately) and one or more memories (not shown separately). The one or more processors of the processing circuitry 102 can be configured to, either separately or in any appropriate combination, execute several functional modules in accordance with computer-readable instructions implemented on a non-transitory computer-readable memory comprised in the processing circuitry. Such functional modules are referred to hereinafter as comprised in the processing circuitry.

According to certain embodiments, one or more functional modules comprised in the processing circuitry 102 of system 101 can include a machine learning (ML) model 106, a training module 104 configured to train the ML model 106, and a significance estimation module 108 operatively connected to each other.

Specifically, the training module 104 can be configured to obtain, via an I/O interface 126, a first dataset comprising a group of defect candidates resulting from examining a semiconductor specimen. Each defect candidate is characterized by a set of attributes and is associated with a respective ground truth (GT) label indicative of a class thereof. The training module 104 can be further configured to train the ML model 106 using the first dataset.

Upon the ML model being trained, the significance estimation module 108 can be configured to estimate, for each attribute in the set of attributes, a first significance value based on the trained ML model. The first significance value is indicative of a level of relevance or importance of the attribute contributing to correct classification of the group of defect candidates by the ML model.

The training module 104 can be configured to generate one or more second datasets based on the first dataset. Each second dataset comprises the group of defect candidates, each associated with a synthetic label assigned to disrupt correlation between the defect candidate and the respective GT label thereof. The training module 104 can be further configured to retrain the ML model respectively using the one or more second datasets. The significance estimation module 108 can be configured to estimate, for each attribute, one or more second significance values based on one or more respectively retrained ML models.

The significance estimation module 108 can be configured to calculate a normalized significance value for each attribute based on the first significance value and the one or more second significance values of the attribute, and select a subset of attributes from the set of attributes based on their respective normalized significance values.

According to certain embodiments, the ML model 106 can be implemented as various types of machine learning models. By way of example, the ML model can be implemented as one of the following: various tree-based models (such as, e.g., decision trees, random forests, and gradient boosted trees), regression models, neural networks, statistical models, and/or ensembles/combinations thereof. The learning algorithms used by the ML models can be any of the following: supervised learning, unsupervised learning, self-supervised, semi-supervised learning, or a combination thereof, etc. The presently disclosed subject matter is not limited to the specific types of the ML model or the specific types of learning algorithms used by the ML model.

By way of example, in some cases, the ML model can be implemented as a deep neural network (DNN). DNN can comprise multiple layers organized in accordance with respective DNN architecture. By way of non-limiting example, the layers of DNN can be organized in accordance with architecture of a Convolutional Neural Network (CNN), Recurrent Neural Network, Recursive Neural Networks, autoencoder, Generative Adversarial Network (GAN), or otherwise. Optionally, at least some of the layers can be organized into a plurality of DNN sub-networks. Each layer of DNN can include multiple basic computational elements (CE), typically referred to in the art as dimensions, neurons, or nodes.

The parameters of the ML model can be initially selected prior to training, and can be further iteratively adjusted or modified during training to achieve an optimal set of parameter values in a trained model. Training can be determined to be complete when a loss/cost function, indicative of the error value, is less than a predetermined value, or when a limited change in performance between iterations is achieved. A set of input data used to adjust the parameters of an ML model is referred to as a training set.

By way of example, the weighting and/or threshold values associated with the CEs of a DNN and the connections thereof can be iteratively adjusted or modified during training to reduce the difference between the actual output produced by DNN module and the target output associated with the respective training set of data.

It is noted that the teachings of the presently disclosed subject matter are not bound by specific architecture of the ML models as described above.

It is to be noted that while certain embodiments of the present disclosure refer to the processing circuitry 102 being configured to perform the above-recited operations, the functionalities/operations of the aforementioned functional modules can be performed by the one or more processors in processing circuitry 102 in various ways. By way of example, the operations of each functional module can be performed by a specific processor, or by a combination of processors. The operations of the various functional modules, such as the ML model training and retraining, dataset generation, and significance estimation, etc., can thus be performed by respective processors (or processor combinations) in the processing circuitry 102, while, optionally, these operations may be performed by the same processor. The present disclosure should not be limited to being construed as one single processor always performing all the operations.

In some cases, additionally to system 101, the examination system 100 can comprise one or more examination modules, such as, e.g., defect detection module, nuisance filtration module, Automatic Defect Review Module (ADR), Automatic Defect Classification Module (ADC), metrology operation module, and/or other examination modules which are usable for examination of a semiconductor specimen. The one or more examination modules can be implemented as stand-alone computers, or their functionalities (or at least part thereof) can be integrated with the examination tools 120. In some cases, the output of system 101, e.g., the normalized significance values, and/or the selected subset of attributes, can be provided to the one or more examination modules (such as the ADR, ADC, etc.) for further processing.

According to certain embodiments, system 100 can comprise a storage unit 122. The storage unit 122 can be configured to store any data necessary for operating system 101, e.g., data related to input and output of system 101, as well as intermediate processing results generated by system 101. By way of example, the storage unit 122 can be configured to store the first and second datasets, including various representations of defect candidates and/or derivatives thereof produced by the examination tool 120, as well as the set of attributes characterizing the defect candidates and the labels thereof, as described above. Accordingly, the different types of input data as required can be retrieved from the storage unit 122 and provided to the processing circuitry 102 for further processing. The output of the system 101, such as, e.g., the normalized significance values, and/or the selected subset of attributes, can be sent to storage unit 122 to be stored.

In some embodiments, system 100 can optionally comprise a computer-based Graphical User Interface (GUI) 124 which is configured to enable user-specified inputs related to system 101. For instance, the user can be presented with a visual representation of the specimen (for example, by a display forming part of GUI 124), including the images of the defect candidates, etc. The user may be provided, through the GUI, with options of defining certain operation parameters, such as, e.g., a threshold to be applied on the normalized significance values, and the minimum number of selected attributes, etc. The user may also view the operation results or intermediate processing results, such as, e.g., the selected subset of attributes, etc., on the GUI.

In some cases, system 101 can be further configured to send, via I/O interface 126, the operation results to the examination tools 120 for further processing. In some cases, system 101 can be further configured to send the results to the storage unit 122, and/or external systems (e.g., Yield Management System (YMS) of a fabrication plant (fab)). A yield management system (YMS) in the context of semiconductor manufacturing is a data management, analysis, and tool system that collects data from the fab, especially during manufacturing ramp-ups, and helps engineers find ways to improve yield. YMS helps semiconductor manufacturers and fabs manage high volumes of production analysis with fewer engineers. These systems analyze the yield data and generate reports. YMS can be used by Integrated Device Manufacturers (IMD), fabs, fabless semiconductor companies, and Outsourced Semiconductor Assembly and Test (OSAT).

Those versed in the art will readily appreciate that the teachings of the presently disclosed subject matter are not bound by the system illustrated in FIG. 1. Each system component and module in FIG. 1 can be made up of any combination of software, hardware, and/or firmware, as relevant, executed on a suitable device or devices, which perform the functions as defined and explained herein. Equivalent and/or modified functionality, as described with respect to each system component and module, can be consolidated or divided in another manner. Thus, in some embodiments of the presently disclosed subject matter, the system may include fewer, more, modified and/or different components, modules, and functions than those shown in FIG. 1.

Each component in FIG. 1 may represent a plurality of the particular components, which are adapted to independently and/or cooperatively operate to process various data and electrical inputs, and for enabling operations related to a computerized examination system. In some cases, multiple instances of a component may be utilized for reasons of performance, redundancy, and/or availability. Similarly, in some cases, multiple instances of a component may be utilized for reasons of functionality or application. For example, different portions of the particular functionality may be placed in different instances of the component.

It should be noted that the examination system illustrated in FIG. 1 can be implemented in a distributed computing environment, in which one or more of the aforementioned components and functional modules shown in FIG. 1 can be distributed over several local and/or remote devices. By way of example, the examination tools 120, and the system 101 can be located at the same entity (in some cases hosted by the same device) or distributed over different entities, depending on specific system configurations and implementation needs.

In some examples, certain components utilize a cloud implementation, e.g., are implemented in a private or public cloud. Communication between the various components of the examination system, in cases where they are not located entirely in one location or in one physical entity, can be realized by any signaling system or communication components, modules, protocols, software languages, and drive signals, and can be wired and/or wireless, as appropriate.

It should be further noted that in some embodiments at least some of examination tools 120, storage unit 122 and/or GUI 124 can be external to the examination system 100 and operate in data communication with systems 100 and 101 via I/O interface 126. System 101 can be implemented as stand-alone computer(s) to be used in conjunction with the examination tools, and/or with the additional examination modules as described above. Alternatively, the respective functions of the system 101 can, at least partly, be integrated with one or more examination tools 120, thereby facilitating and enhancing the functionalities of the examination tools in examination-related processes.

While not necessarily so, the process of operations of systems 101 and 100 can correspond to some or all of the stages of the methods described with respect to FIGS. 2-4. Likewise, the methods described with respect to FIGS. 2-4 and their possible implementations can be implemented by systems 101 and 100. It is therefore noted that embodiments discussed in relation to the methods described with respect to FIGS. 2-4 can also be implemented, mutatis mutandis as various embodiments of the systems 101 and 100, and vice versa.

Referring to FIG. 2, there is illustrated a generalized flowchart of automatic attribute selection in accordance with certain embodiments of the presently disclosed subject matter.

As described above, a semiconductor specimen is typically made of multiple layers. The examination process of a specimen can be performed a multiplicity of times during the fabrication process of the specimen, for example following the processing steps of specific layers. In some cases, a sampled set of processing steps can be selected for in-line examination, based on their known impacts on device characteristics or yield. Images of the specimen or parts thereof can be acquired at the sampled set of processing steps to be examined.

For the purpose of illustration only, certain embodiments of the following description are described with respect to a group of defect candidates resulting from examining a given processing step/layer of the sampled set of processing steps. Those skilled in the art will readily appreciate that the teachings of the presently disclosed subject matter, such as the process of automatic attribute selection described below, can be performed based on training datasets of defect candidates from any layer and/or processing steps of a specimen. The present disclosure should not be limited to the number of layers comprised in the specimen and/or the specific layer(s) to be examined.

A first dataset can be obtained (202) (e.g., by the training module 104), comprising a group of defect candidates resulting from examining a semiconductor specimen. Each defect candidate is characterized by a set of attributes and is associated with a respective ground truth (GT) label indicative of a class of the defect candidate.

As described above, defect candidates of a semiconductor specimen are typically characterized by a wide range of attributes spanning various dimensions. In some embodiments, in cases where the defect candidates result from wafer inspection, the attributes of the defect candidates can refer to inspection attributes obtained during the inspection process by an inspection tool, e.g., based on certain characteristics of the inspection image(s) and/or the defect map(s). By way of example, during inspection, an inspection tool can capture inspection images of a specimen (e.g., a wafer, a die, or part thereof). The captured images of the specimen can be processed using various defect detection algorithms to generate a defect map indicative of defect candidate distribution on the specimen. The generated defect map can be informative of inspection attributes, such as, e.g., locations, strength, size, volume, grade, and polarity, etc. of the defect candidates. Optionally, in some cases, additional attributes can be also collected, including image characteristics corresponding to the defect candidates such as, e.g., gray level intensities, contrast, etc., as well as acquisition information, such as acquisition time, acquisition tool ID, region ID, wafer ID, etc. In cases where a defect classifier or a nuisance filter has been previously applied to classify/filter the defect candidates, a probability score of each defect candidate being a DOI can be added as an additional inspection attribute.

In some embodiments, in addition to or in lieu of the above hand-crafted defect attributes, the set of attributes can include one or more abstract attributes retrieved from a neural network used to pre-process the group of defect candidates. Unlike traditional hand-crafted attributes, these abstract attributes are learned representations that capture complex patterns and features identified by the neural network during processing. For instance, attributes extracted from the final layer before the output layer of a neural network, such as a convolutional neural network (CNN), represent high-level, abstracted information on each defect candidate. These abstract attributes are advantageous as they encapsulate nuanced details that might be challenging to represent using conventional attributes, allowing the system to leverage the network's ability to recognize intricate patterns and correlations within the data.

By incorporating these learned attributes, the system can achieve enhanced classification accuracy and robustness, as the ML model benefits from both high-level abstract insights and traditional, interpretable defect features, providing a more comprehensive characterization of each defect candidate. This approach may enhance the system's adaptability to diverse defect types and manufacturing conditions, as neural network-derived attributes may be particularly effective at capturing subtle differences in defect patterns.

Each defect candidate in the first dataset is associated with its respective ground truth (GT) label indicative of the class of the defect candidate. For instance, in cases of a binary classification, there are two GT labels associated with the defect candidates: DOI or nuisance. The GT labels can be obtained in various ways, such as, e.g., via manual annotation, from a review tool, etc. By way of example, a review tool (e.g., SEM) can be used to capture review images with higher resolution at locations of the defect candidates, and review the review images for ascertaining whether a defect candidate is a DOI or nuisance. The output of the review tool includes defect classes/types respectively associated with the defect candidates. The defect classes/types of the candidates provided by the review tool can be regarded as ground truth labels of these candidates.

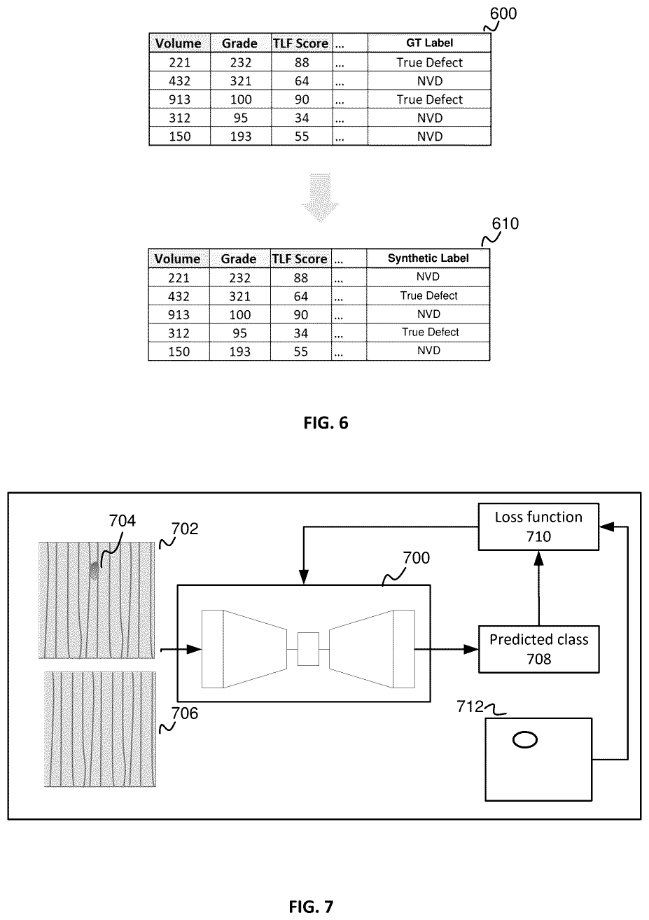

The first dataset of defect candidates can be represented in different types of data representations. By way of example, the group of defect candidates, as well as the attributes associated therewith, can be represented in a tabular form, as exemplified with reference to FIG. 6.

FIG. 6 shows a schematic illustration of an example of a first dataset and a second dataset (as will be described in detail below) in accordance with certain embodiments of the presently disclosed subject matter.

A first dataset 600 is exemplified as a tabular dataset. The dataset 600 comprises N defect candidates stored in a table, where each row represents a specific defect candidate in the set of defect candidates, and each column represents an attribute of the defect candidate (e.g., an inspection attribute in the present example).

The inspection attributes obtained during defect inspection can include locations, strength, size, volume, grade, polarity, etc. of the defect candidates. In the present example, a probability score of each defect candidate being a DOI is added as an additional inspection attribute (denoted as “TLF score” in the dataset 600). The probability score can be previously derived by a defect classifier or a nuisance filter used for classifying/filtering the defect candidates.

In addition to the inspection attributes, the training set also includes a column representative of the GT labels of the defect candidates. In the present example, the set of defect candidates can be reviewed by a review tool, such as a SEM, to provide their GT labels. As illustrated, the dataset 600 includes a column named “GT label” indicative of the ground truth labels of the candidates as provided by the SEM (where “true defect” represents a DOI, while “NVD” represents a nuisance).

The inspection attributes derived from one or more specimens and the GT labels of the defect candidates constitute the first dataset 600. The first dataset 500 can be used to train a ML model, as will be detailed below.

It is to be noted that although the first dataset 600 as illustrated in FIG. 6 is demonstrated in the format of a table, this is for exemplary purposes only, and should not be regarded as limiting the present disclosure. Any other suitable representation of such a dataset, including defect candidates and the attributes thereof, can be used in lieu of the tabular format. For instance, in some cases, any of the following table-like structures can be used instead of the tabular format, when appropriate: lists, graphs, matrices, or general binary relations, etc. In some cases, the first dataset of defect candidates can be represented in other types of data representations, such as an image dataset, e.g., image patches extracted from the inspection images.

For instance, for each defect candidate detected from an inspection image of the specimen, an inspection patch comprising the defect candidate can be extracted from the inspection image. The inspection patch can be cropped from the inspection image according to a bounding box placed around the candidate. The inspection patch can be cropped at various sizes, such as, e.g., 32×32 pixels, 64×64 pixels, or any other suitable sizes/dimensions. In such cases, the training set can comprise a set of inspection patches corresponding to a set of defect candidates detected from the specimen. It is also possible that the training set can comprise an inspection image of the training specimen, where each defect candidate is marked at its respective location.

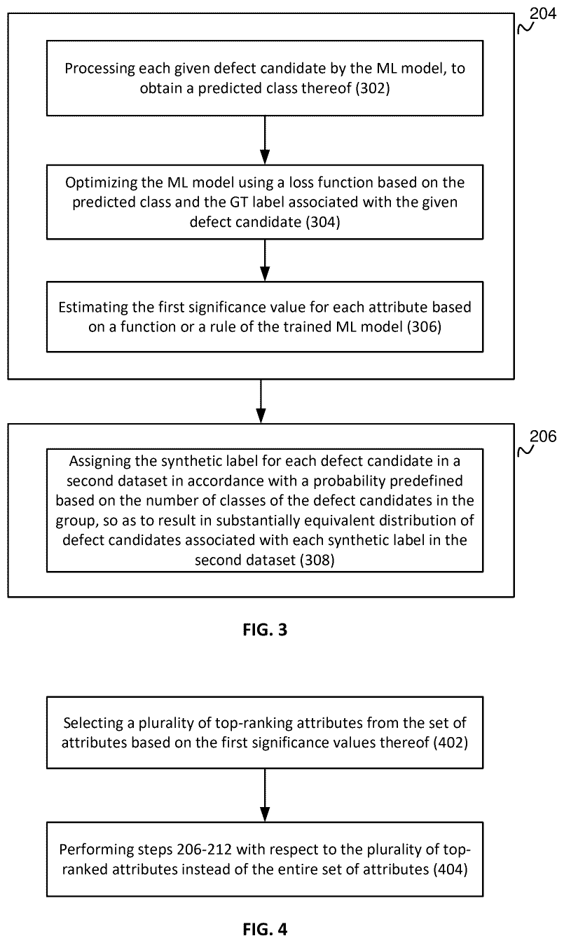

The first dataset can be used to train (204) (e.g., by the training module 104) an ML model (e.g., the ML model 106). The ML model can be trained using supervised learning, as exemplified below with reference to FIG. 3 and FIG. 7. Once the ML model is trained, a first significance value can be estimated (e.g., by the significance estimation module 108) for each attribute in the set of attributes, based on the trained ML model. The first significance value is indicative of a level of relevance/importance of the attribute in contributing to correct classification of the group of defect candidates.

FIG. 3 illustrates a generalized flowchart exemplifying implementation details of certain operations with respect to FIG. 2 (such as steps 204 and 206) in accordance with certain embodiments of the presently disclosed subject matter.

Upon obtaining the first dataset, the ML model can be trained as follows: for each given defect candidate in the group, processing (302) the given defect candidate by the ML model, to obtain a predicted class thereof, and optimizing (304) the ML model using a loss function based on the predicted class and the GT label associated with the given defect candidate.

FIG. 7 shows a schematic illustration of a training process of the ML model in accordance with certain embodiments of the presently disclosed subject matter.

An ML model 700 is exemplified in FIG. 7. The ML model 700 can be implemented in various types and architectures, as described above. For training the ML model, a first dataset of defect candidates is obtained. The dataset can be represented in various formats, such as in the form of a tabular dataset (as exemplified by dataset 600) or an image dataset. For purpose of illustration, the first dataset 600 is demonstrated as including one or more training inspection patches, each containing a defect candidate labelled as a DOI, such as, e.g., the training patch 702 containing a DOI 704. The first dataset also includes one or more training inspection patches, each containing a defect candidate labelled as a nuisance or false alarm, such as, e.g., the training patch 706 (where no DOI is marked).

The dataset can be fed into the ML model 700 to be processed. For instance, the ML model 700 can be implemented as a neural network, such as a DNN (e.g., CNN). Taking CNN as an exemplified implementation of the ML model, during the forward pass, convolutional operations are performed on each training patch, so as to learn to capture representative features. For each specific layer in the CNN, output feature maps can be generated, e.g., by convolving each filter of the specific layer across the width and height of the input feature maps, and producing a two-dimensional activation map which gives the responses of that filter at every spatial position. Stacking the activation maps for all filters along the depth dimension forms a full output feature map of the specific layer, representative of extracted features/attributes of a given input training patch. After feature extraction through convolutional layers, additional layers such as fully connected layers and an output layer can convert the output feature maps into probability scores for each class, and the class with the highest probability is selected as the predicted class for a given training inspection patch.

The ML model can thus provide a predicted class 708 (in some cases the predicted class can be associated with a predicted probability of the candidate belonging to the predicted class) based on it. The predicted class 708 can be evaluated with respect to the ground truth label 712 of DOI 704, using a loss function 710 (e.g., a classification loss, such as, e.g., Cross Entropy, or Squared Hinge, etc.). The parameters of the ML model can be optimized to reduce/minimize the difference between the predicted class 708 and the ground truth label 712.

Once the ML model is trained, the first significance value can be estimated (306) for each attribute based on a function or a rule of the trained ML model. By way of example, in cases where the ML model is implemented as a boosted tree (such as, e.g., a CatBoost model), the significance value can be estimated by calling a function in the model, such as the function of “Get feature importance”. By way of another example, in cases where the ML model is implemented as a decision tree, the significance value for each attribute can be estimated using a rule related to the number of times the attribute is relied upon for class prediction. By way of further example, in cases where the ML model is implemented as an NN, the significance value for each attribute can be estimated using model-agnostic methods (such as, e.g., Shapley values (SHAP)) or model-specific methods. These methods can be applied to the trained NN, to obtain an explanation regarding to which extent the NN relies on each attribute, thus providing an indication of the significance value thereof.

Continuing with the description of FIG. 2, one or more second datasets can be generated (206) (e.g., by the training module 104) based on the first dataset. Each second dataset comprises the same group of defect candidates from the first dataset, with each defect candidate now associated with a synthetic label assigned in a manner designed to disrupt correlation between the defect candidate and its respective GT label. These second datasets are designed to assist in creating a non-informative setting, which refers to a setting where the correlation or dependency between defect candidates and their GT labels has been neutralized. By breaking the correlation, the system provides a complementary context for unbiased significance estimation.

In the first dataset, which represents an informative setting, each defect candidate's GT label correlates with its actual class, allowing the ML model to learn a clear and meaningful mapping relationship between the candidate's attributes and its class. However, to evaluate attribute importance in an unbiased manner, it is beneficial to disrupt this relationship, creating non-informative settings that allow for independent re-estimation of attribute significance without the influence of the original GT label correlation. In this way, each attribute's significance can be assessed, both in informative and non-informative settings.

The first significance value calculated in the informative setting (i.e., using the first dataset) reflects each attribute's level of relevance in contributing to correctly classifying defect candidates when GT labels are informative. The first significance value thus reflects the prediction strength between each attribute and the model's classification output in the presence of informative GT labels. However, significance values derived in informative settings may be biased, particularly if certain attributes have a high number of categories or a broader range, as these attributes can disproportionately influence model predictions. To gauge the robustness of these significance values and avoid bias towards attributes with high variability or categorical breadth, non-informative settings are generated through synthetic label assignments. It is thus possible to re-estimate each attribute's significance in scenarios where the relationship between attributes and GT labels has been neutralized. These non-informative settings serve as a benchmark to assess each attribute's true significance, ultimately enabling the calculation of a normalized significance value that incorporates both informative and non-informative contexts, thus reducing bias.

When generating a second dataset, it is possible to simply shuffle the labels present in the first dataset, such that each defect candidate can be re-assigned with a new label. However, in cases where the dataset is imbalanced, such as, e.g., a dataset where the majority of the samples belong to one class, while the remaining samples belong to the other class (which is typically the case in the field of semiconductor examination data), simply reshuffling the labels is not ideal to break the correlation or dependency between the candidates and their GT labels. For instance, consider a typical semiconductor inspection dataset, where defect candidates are predominantly labeled as “nuisance” (e.g., comprising 90% of the dataset), with the remaining 10% labeled as “DOI.” In such an imbalanced dataset, simply reshuffling the labels may still retain the original class distribution, leaving many defect candidates with the same label (e.g., most of the 90% samples will likely retain the same label). This would limit the effectiveness of creating a truly non-informative setting. In fact, when creating the second datasets, it is often desired to minimize the probability of any defect candidate retaining its original label, while maximizing the probability of the defect candidates receiving a different label.

Assigning synthetic labels to disrupt GT-label correlation, and thereby create non-informative settings, can be implemented using various methods. For addressing the above issues and creating these non-informative settings, certain embodiments of the presently disclosed subject matter propose that when generating (206) the one or more second datasets, synthetic labels in each second dataset are randomly assigned (308) according to a predefined probability based on the number of classes present in the first dataset, ensuring an approximately/substantially equivalent distribution of defect candidates across all synthetic labels. For instance, if the first dataset includes two classes, A and B, indicating two types of defect candidates, then the probability for assigning a synthetic label of A or B to each defect candidate is predefined as [50%, 50%]. This means that each defect candidate has a substantially equal probability of being assigned either synthetic label A or synthetic label B, achieving a balanced label distribution in the second dataset. In cases where the first dataset contains more than two classes, such as N classes, the probability of assigning each label can be set at 100%/N. This ensures that each class is substantially equally represented in the newly generated second datasets, resulting in a substantially equivalent distribution of defect candidates for each synthetic label.

It should be noted that the term “random” as used herein encompasses not only purely random assignments but also pseudo-random or other forms of controlled randomness. These can include methods where labels are assigned based on stochastic processes, algorithms, or predefined probabilities that simulate randomness while adhering to specific constraints or desired distributions. This flexibility allows for practical implementations where absolute randomness may not be achievable or desirable. Minor variations or deviations due to practical constraints, statistical fluctuations, or inherent randomness are also considered within the scope of the disclosed embodiments, provided they achieve the intended effect of disrupting GT-label correlation and ensuring a balanced distribution of synthetic labels, thereby enabling the creation of effective non-informative settings.

Regarding the terms “substantially” or “approximately” as used herein, it should be noted that these terms are intended to convey that minor variations in probability or distribution may exist due to practical limitations, statistical fluctuations, or inherent randomness in the label assignment process. The use of “substantially” or “approximately” is not intended to imply absolute equivalence but rather an effective and close balance across classes that achieves the intended technical effect of creating non-informative settings with an approximately equivalent representation of each synthetic label. For instance, the probability of assigning a synthetic label of A or B to each defect candidate is predefined as [50%, 50%], while the actual probability of being assigned either synthetic label may be approximately or substantially around 50%, such as, e.g., [48%, 52%], or [55%, 45%], etc. Accordingly, small deviations from exact probabilities or distribution are within the scope of the disclosed embodiments, as they do not materially impact the overall balanced nature of the synthetic datasets.

In the above example of a typical semiconductor inspection dataset where 90% is labeled as “nuisance” while the remaining 10% is labeled as “DOI”, by randomly assigning synthetic labels based on the balanced probability distribution, the probability of any defect candidate retaining its original GT label is minimized (i.e., lower P(A|A) or P(B|B)), while the probability of each defect candidate receiving a different label is maximized (i.e., higher P(A|B) or P(B|A)). This approach ensures that each second dataset represents a non-informative setting, effectively disrupting the original GT label correlation. The proposed approach can result in creating second datasets with balanced synthetic labels.

While synthetic labels may be assigned randomly in some embodiments as described above to create non-informative settings, the essential characteristic of these labels is their lack of correlation with the set of attributes and ground truth labels of the defect candidates. Therefore, in some other embodiments, synthetic labels can be assigned systematically or according to certain predefined patterns that effectively break the correlation between defect candidates and their GT labels. Optionally, these systematic assignments can be performed in accordance with a predefined probability based on the number of classes present in the first dataset, ensuring an approximately/substantially equivalent distribution of defect candidates across all synthetic labels, as described above.

Various methods, such as predefined patterns, ordered assignments, or probabilistic models, may also be employed to achieve the systematic assignment, provided they effectively disrupt any meaningful relationship between the original GT labels and the assigned synthetic labels. For example, synthetic labels could be assigned in a cyclic order or based on a mapping function designed to ensure that no dependency exists between the original GT labels and the newly assigned synthetic labels. The present disclosure is not limited by the specific method used, as long as the objective of disrupting the GT-label correlation is achieved.

In the example of FIG. 6, a second dataset 610 has been generated based on the first dataset 600 according to the above proposed approach. As shown, synthetic labels are assigned to the defect candidates in the first dataset in accordance with the predefined probability of [50%, 50%]. For instance, the first defect candidate which has a GT label of “true defect” has now been assigned with a synthetic label of “NVD”, while the second defect candidate, which has a GT label of “NVD”, has now been assigned with a synthetic label of “true defect”, effectively disrupting the GT label correlation.

In the non-informative settings where the synthetic labels are uncorrelated with the attributes, the ML model can be retrained (208) (e.g., by the training module 104) respectively using the generated one or more second datasets. The retraining of the ML model can be performed in a similar manner as the training process described above with reference to block 204. One or more second significance values can be estimated for each attribute, based on the one or more respectively retrained ML models. These second significance values, calculated in the non-informative settings, serve as less biased re-estimations of each attribute's significance value, and provide a benchmark for the attribute's importance in scenarios where the defect candidate's attributes are statistically decoupled from its true class.

By way of example, assume M second datasets are generated for a first dataset (the number M can be determined based on the desired level of estimation precision with respect to the computational cost). The ML model is thus retrained M times, each time with a respective second dataset and giving rise to a respective second significance value for each attribute. Therefore, after the M times retraining, each attribute is associated with M second significance values corresponding to the M second datasets, in addition to the first significance value corresponding to the first dataset.

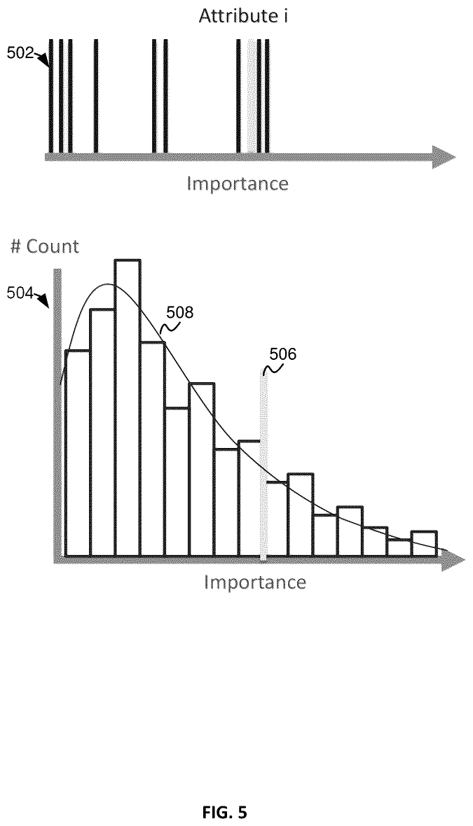

Once the second significance values are obtained, they can be combined with the first significance value, calculated in the informative setting, to derive a normalized significance value. Specifically, a normalized significance value can be calculated (210) (e.g., by the significance estimation module 108) for each attribute based on the first significance value and the one or more second significance values of the attribute as illustrated in FIG. 2. By way of example, the normalized significance value can be calculated for each given attribute based on a ratio between the number of second significance values higher than/exceeding the first significance value, and the number of second significance values. This ratio may indicate how often the attribute's importance score in the non-informative setting surpasses its importance score in the informative setting, effectively acting as a statistical measure of significance. By way of another example, in particular in cases of small sample size, the normalized significance value can be calculated by fitting a distribution (such as, e.g., the fitted distribution 508 exemplified in FIG. 5) to the second significance values, and estimating the normalized value based on the fitted distribution. For instance, the area under the fitted distribution 508 and greater than the first significance value can provide an indication of the normalized significance value.

A subset of attributes can be selected (212) from the set of attributes based on their respective normalized significance values.

The normalized significance value provides an adjusted measure of an attribute's importance by comparing its performance in informative and non-informative settings. This normalization process helps to reduce inherent biases associated with attributes that may have high variability or large categorical ranges, which could otherwise inflate their apparent significance. By normalizing the significance values, a more balanced and unbiased assessment of each attribute's relevance can be obtained. In particular, the normalized significance value can be regarded as representing statistical importance of the given attribute, with reduced bias compared to the first significance value of the given attribute.

FIG. 5 shows an exemplary illustration of the first significance value and the distribution of the second significance values of a given attribute (referred to as attribute i) in accordance with certain embodiments of the presently disclosed subject matter.

Graph 502 displays the first significance values for a set of attributes, ranked along the X-axis according to their values, reflecting their relative importance in the context of defect classification. As shown, attribute i is ranked as the third most important attribute based on its first significance value within this ranking.

Graph 504 illustrates the histogram distribution of M second significance values for attribute i, obtained after retraining the ML model using each of the M second datasets. In Graph 504, the Y-axis represents the count (or frequency) of each specific second significance value, while the X-axis reflects the ordered ranking of these values. The first significance value 506 of attribute i is also represented on Graph 504 for comparison purposes, positioned according to its value relative to the distribution of second significance values. As exemplified, the normalized significance value of attribute i can be calculated by taking the ratio of the number of second significance values that exceed the first significance value 506 (i.e., the sum of the counts to the right of the first significance value 506) to the total number of second significance values (i.e., M). This ratio provides a measure of how often attribute i's significance in non-informative settings surpasses its significance in the informative setting, serving as a normalized indication of the attribute's true importance.

In certain embodiments, a threshold for the normalized significance ratio may be predefined to aid in attribute selection. For instance, a threshold of 5% could be set, meaning that if the ratio for attribute i exceeds 5%, then attribute i's importance in the non-informative settings surpasses its importance in the informative setting more than 5% of the time. A ratio below this threshold would indicate that the first significance value is not derived from the bias in the training data, while a ratio above this threshold suggests that the first significance value is contaminated by the bias in the training data. Consequently, attribute i may be excluded from the selected subset of attributes to enhance the overall efficiency and relevance of the chosen attributes.

As illustrated in FIG. 4, in some embodiments, prior to generating the one or more second datasets, a plurality of top-ranking attributes can be selected (402) from the set of attributes based on the first significance values thereof, and the subsequent steps of generating, retraining, calculating, and selecting, as described with reference to blocks 206-212 can be performed (404) with respect to the plurality of top-ranking attributes in place of the set of attributes, so as to improve computational efficiency.

To select the plurality of top-ranking attributes, various criteria can be applied to ensure that the most impactful attributes are chosen based on their contribution to classification accuracy. The number of attributes to be selected can be determined based on the desired level of estimation precision, with respect to computational cost/efficiency.

One approach can be selecting attributes based on the proportion of their first significance values in relation to the total sum of all first significance values across the set of attributes. For example, attributes may be ranked by their first significance values, and then the first n attributes that collectively contribute up to 90% of the total significance value sum are selected. This approach ensures that the selection captures the most influential attributes, without unnecessary redundancy.

Alternatively, a threshold-based approach can be used in some cases, where only attributes with a first significance value above a predefined threshold (e.g., greater than 5% of the maximum significance value in the set) are selected. This method may be beneficial when a precise cutoff for attribute importance is known or desirable, allowing the system to focus solely on highly impactful attributes. Another option is to set a fixed number of top-ranking attributes, such as selecting the top 10 or top 20 attributes, based on their first significance values. This approach can be particularly useful when computational efficiency is prioritized, as it limits the number of attributes processed in subsequent steps.

The selected subset of attributes, chosen based on their respective normalized significance values, has diverse applications in the examination and classification of defect candidates in semiconductor manufacturing. By refining the set of attributes to those most relevant to defect characterization, various processes can benefit from enhanced accuracy, efficiency, and interpretability.

By way of example, the selected subset of attributes can serve as a focused set of features for defining/characterizing a training dataset usable to train a classifier for defect classification. In this application, the classifier model is trained using only the most significant attributes, ensuring that irrelevant or noisy data does not interfere with the learning process. This refined set of attributes not only reduces model complexity, which can result in faster training times and lower computational requirements, but also enhances model generalizability by focusing on the core characteristics that are critical to defect classification. By using only the most impactful attributes, the classifier can achieve higher accuracy in identifying true defects (e.g., defects of interest or DOIs) versus nuisance or false alarms, thus increasing both the precision and efficiency of defect detection workflows in semiconductor manufacturing.

In addition to or in lieu of defect classification, the selected subset of attributes is also valuable for defect ranking, where defect candidates are ordered according to their likelihood of impacting yield or product quality. By using attributes that have been carefully chosen for their relevance, defect candidates can be ranked based on their probability of being a true defect of interest. Such defect ranking, powered by a subset of impactful attributes, can integrate seamlessly into automated inspection systems to allow prioritizing their efforts and focusing on the most significant defects first. It helps to streamline the review process, reduce time to resolution, and enable rapid feedback loops in production.

One specific use case of a ML trained as such is automatic defect offset correction between an inspection tool and a review tool, where the offset is caused by mismatch/discrepancy between the inspection and the review coordinate systems of the tools. In such cases, the ML model can be used for purpose of selection of anchoring defects, which are true defects (i.e., DOIs) captured during both inspection and review, and used for deriving the transformation between the two coordinate systems. For instance, the offset between the two coordinate systems can be represented by a transformation matrix comprising a plurality of transformation coefficients corresponding to a plurality of degrees of freedom of transformation between the inspection coordinate system and the review coordinate system.

Specifically, in such use cases, the ML model can be used to provide, for each defect candidate in a group of defect candidates resulting from defect inspection, a probability of the defect candidate being a defect of interest (DOI), and rank the group of defect candidates to an ordered list of defect candidates according to respective probabilities thereof. The ordered list of defect candidates can be sent to a review tool to be reviewed for purpose of efficiently identifying sufficient anchoring defects. Using the ML model specifically trained as such enables the review tool, when reviewing the defect candidates according to the order, to sample a relatively small number of defect candidates, and efficiently locate the required number of anchoring defects, as compared to traversing and verifying each defect candidate in a non-ordered manner (e.g., randomly).

By way of example, assuming the group of defect candidates consists of N candidates, among which M DOIs should be selected as anchoring defects, the ML model should be able to rank the N candidates to an order of 1−N, such that when the review tool reviews the candidates sequentially according to the order (e.g., starting from the candidate ranked as No. 1 in the order), it can sample fewer candidates and identify M DOIs as quickly as possible (i.e., with minimum trial and error).

In some cases, after the review and identification of anchoring defects, the identified anchoring defects can be further filtered according to their relevancy (e.g., suitability/appropriateness) to be used for offset correction. By way of example, a defect can be considered as relevant/suitable for offset correction in terms of its geometrical properties, such as, e.g., size, shape, and location in the FOV, etc. For instance, the size of a suitable defect should not be too large. A certain dimension of the defect, such as length or width, should not be too long. This is because a large defect may occupy or exceed the FOV, making it difficult to measure the offset. In another example, the location of the defect is preferable to be close to the center and not to the margin/edge of the FOV. Therefore, in some cases, the anchoring defects can be further filtered based on their geometrical properties. For instance, the defects, whose size/dimension is within a predetermined range and located in a predefined region of the FOV, can be selected.

Additionally or alternatively to the above-mentioned use cases, the selected subset of attributes can be applied for clustering or unsupervised binning of defect candidates. In such cases, the subset of attributes acts as a dimensional basis for grouping defect candidates that exhibit similar characteristics. By focusing on attributes that have high normalized significance values, clustering algorithms, such as K-means, hierarchical clustering, or density-based clustering, can group defect candidates more accurately, based on true similarities rather than noise or less relevant details. This targeted clustering enables manufacturers to gain insights into patterns of defect occurrence, identify root causes linked to specific manufacturing processes or equipment, and establish quality control measures that can address systemic issues. Additionally, by grouping defects based on highly relevant attributes, manufacturers can more effectively categorize and prioritize defects, ensuring that critical issues receive prompt attention.

It is to be noted that examples illustrated in the present disclosure, such as, e.g., the exemplified defects and representations, the exemplified ML model, the training datasets, the specific calculations of significance values, etc., are illustrated for exemplary purposes, and should not be regarded as limiting the present disclosure in any way. Other appropriate examples/implementations can be used in addition to, or in lieu of the above.

Among the advantages of certain embodiments of the presently disclosed subject matter as described herein, is providing an automatic attribute selection system capable of identifying and selecting a subset of the most relevant attributes for machine learning-based defect examination in semiconductor manufacturing, while reducing bias and achieving statistically meaningful significance values. This system automatically evaluates attribute significance in both informative and non-informative settings, ensuring that only the attributes with the highest normalized relevance are retained, supporting more reliable and accurate defect examination.

Among further advantages of certain embodiments of the presently disclosed subject matter as described herein, is the mitigation of bias in attribute significance estimation, enhancing the overall accuracy and robustness of the ML model. The proposed subject matter incorporates non-informative settings through synthetic label assignments, allowing for a normalized significance value calculation that balances informative and non-informative significance assessments. By doing so, the selected attributes are less likely to reflect artificial bias due to high variability or large categorical ranges, which could otherwise skew the attribute selection process. This normalization yields a set of attributes that truly contribute to defect classification, ensuring that the model generalizes effectively across different production scenarios.

Another technical advantage of certain embodiments of the presently disclosed subject matter is the innovative feature of assigning synthetic labels either randomly or systematically in accordance with a probability predefined based on the number of classes of defect candidates present in the first dataset. This probabilistic assignment ensures a substantially equivalent distribution of defect candidates across each synthetic label in the second dataset, creating a balanced non-informative setting that accurately reflects the number of classes without bias toward any single category. By achieving this balanced distribution, the system effectively minimizes the risk of any attribute being overrepresented or underrepresented due to original class imbalances, which is common in defect data in the field of semiconductor examination. This balanced setting enhances the reliability of the normalized significance value calculations, ensuring that attribute importance is evaluated independently of original class distributions. Consequently, this feature contributes to a more statistically valid and unbiased selection of attributes, which directly improves the robustness and generalizability of the ML model in real-world defect classification applications.

Among further advantages of certain embodiments of the presently disclosed subject matter as described herein, is the reduction of computational complexity in machine learning (ML) model training for defect classification. By selecting a subset of top-ranking attributes with significant relevance to classification accuracy, the ML model is able to operate with a more manageable and focused set of input features. This selective approach reduces the data dimensionality and thus accelerates both training and inference times. Reduced dimensionality also lessens memory and processing requirements, making it feasible to deploy the model in real-time applications where quick and reliable classification is essential.

Among further advantages of certain embodiments of the presently disclosed subject matter as described herein, is the option to select a plurality of top-ranking attributes from the set of attributes based on their first significance values, and perform the subsequent steps of generating, retraining, calculating, and selecting with respect to this reduced subset. This targeted approach significantly improves computational efficiency by limiting processing to only the most relevant attributes, reducing the dimensionality and volume of data that the ML model must handle in later stages. By focusing computational resources on a smaller, highly impactful set of attributes, the system achieves faster retraining times, reduced memory requirements, and minimized computational load. This efficiency is particularly valuable in large-scale or real-time defect classification applications, where the ability to quickly retrain or adapt models is crucial.

Among further advantages of certain embodiments of the presently disclosed subject matter as described herein, is the enhancement of defect management workflows across various applications, including clustering and ranking, in addition to defect classification. With a focused attribute subset, clustering algorithms can more accurately group defect candidates with similar characteristics, aiding in root cause analysis and systemic issue identification. Additionally, defect ranking based on these selected attributes prioritizes critical defects for prompt action, making defect management both efficient and effective. This versatile application across workflows provides a comprehensive solution that addresses multiple stages of defect handling, from initial identification to root cause analysis and prioritization.

It is to be understood that the present disclosure is not limited in its application to the details set forth in the description contained herein or illustrated in the drawings.

In the present detailed description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the present discussions, it is appreciated that throughout the specification discussions utilizing terms such as “obtaining”, “examining”, “training”, “estimating”, “generating”, “retraining”, “calculating”, “selecting”, “processing”, “optimizing”, “assigning”, “performing”, “characterizing”, “clustering”, “ranking”, or the like, refer to the action(s) and/or process(es) of a computer that manipulate and/or transform data into other data, said data represented as physical, such as electronic, quantities and/or said data representing the physical objects.

The terms “computer”, “computer-based system” or “computerized system” should be expansively construed to cover any kind of hardware-based electronic device with a data processing circuitry (e.g., digital signal processor (DSP), a graphics processing unit (GPU), a field programmable gate array (FPGA), including, by way of non-limiting example, the examination system, the attribute selection system, and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together.

The one or more processors referred to herein can represent one or more general-purpose processing devices such as a microprocessor, a central processing unit, or the like. More particularly, a given processor may be one of a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

The term “specimen” used in this specification should be expansively construed to cover any kind of physical objects or substrates including wafers, masks, reticles, and other structures, combinations and/or parts thereof used for manufacturing semiconductor integrated circuits, magnetic heads, flat panel displays, and other semiconductor-fabricated articles. A specimen is also referred to herein as a semiconductor specimen, and can be produced by manufacturing equipment executing corresponding manufacturing processes.

The term “examination” used in this specification should be expansively construed to cover any kind of operations related to defect detection, defect review, and/or defect classification of various types, segmentation, and/or metrology operations during and/or after the specimen fabrication process. Examination is provided by using non-destructive examination tools during or after manufacture of the specimen to be examined. By way of non-limiting example, the examination process can include runtime scanning (in a single or in multiple scans), imaging, sampling, detecting, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes (SEM), atomic force microscopes (AFM), optical inspection tools, etc.

The term “metrology operation” used in this specification should be expansively construed to cover any metrology operation procedure used to extract metrology information relating to one or more structural elements on a semiconductor specimen. In some embodiments, the metrology operations can include measurement operations, such as, e.g., critical dimension (CD) measurements performed with respect to certain structural elements on the specimen, including but not limiting to the following: dimensions (e.g., line widths, line spacing, contact diameters, size of the element, edge roughness, gray level statistics, etc.), shapes of elements, distances within or between elements, related angles, overlay information associated with elements corresponding to different design levels, etc. Measurement results such as measured images are analyzed, for example, by employing image-processing techniques. Note that, unless specifically stated otherwise, the term “metrology”, or derivatives thereof used in this specification, is not limited with respect to measurement technology, measurement resolution, or size of inspection area.

The term “defect” used in this specification should be expansively construed to cover any kind of abnormality or undesirable feature/functionality formed on a specimen. In some cases, a defect may be a defect of interest (DOI) which is a real defect that has certain effects on the functionality of the fabricated device, thus is in the customer's interest to be detected. For instance, any “killer” defects that may cause yield loss can be indicated as a DOI. In some other cases, a defect may be a nuisance (also referred to as “false alarm” defect) which can be disregarded because it has no effect on the functionality of the completed device and does not impact yield.

The term “defect candidate” used in this specification should be expansively construed to cover a suspected defect location on the specimen which is detected to have relatively high probability of being a defect of interest (DOI). Therefore, a DOI candidate, upon being reviewed/tested, may actually be a DOI, or, in some other cases, it may be nuisances, or random noise that can be caused by different variations (e.g., process variation, color variation, mechanical and electrical variations, etc.) during inspection.

The term “design data” used in the specification should be expansively construed to cover any data indicative of hierarchical physical design (layout) of a specimen. Design data can be provided by a respective designer and/or can be derived from the physical design (e.g., through complex simulation, simple geometric and Boolean operations, etc.). Design data can be provided in different formats as, by way of non-limiting examples, GDSII format, OASIS format, etc. Design data can be presented in vector format, grayscale intensity image format, or otherwise.

The term “image(s)” or “image data” used in the specification should be expansively construed to cover any original images/frames of the specimen captured by an examination tool during the fabrication process, derivatives of the captured images/frames obtained by various pre-processing stages, and/or computer-generated synthetic images (in some cases based on design data). Depending on the specific way of scanning (e.g., one-dimensional scan such as line scanning, two-dimensional scan in both x and y directions, or dot scanning at specific spots, etc.), image data can be represented in different formats, such as, e.g., as a gray level profile, a two-dimensional image, or discrete pixels, etc. It is to be noted that in some cases the image data referred to herein can include, in addition to images (e.g., captured images, processed images, etc.), numeric data associated with the images (e.g., metadata, hand-crafted attributes, etc.). It is further noted that images or image data can include data related to a processing step/layer of interest, or a plurality of processing steps/layers of a specimen.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination. In the present detailed description, numerous specific details are set forth in order to provide a thorough understanding of the methods and apparatus.

It will also be understood that the system according to the present disclosure may be, at least partly, implemented on a suitably programmed computer. Likewise, the present disclosure contemplates a computer program being readable by a computer for executing the method of the present disclosure. The present disclosure further contemplates a non-transitory computer-readable memory tangibly embodying a program of instructions executable by the computer for executing the method of the present disclosure.

The present disclosure is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the present disclosure as hereinbefore described without departing from its scope, defined in and by the appended claims.

1. A computerized system of attribute selection, the system comprising a processing circuitry configured to:
obtain a first dataset comprising a group of defect candidates resulting from examining a semiconductor specimen, each defect candidate characterized by a set of attributes and associated with a respective ground truth (GT) label indicative of a class thereof;
train a machine learning (ML) model using the first dataset, and estimate, for each attribute in the set of attributes, a first significance value based on the trained ML model, wherein the first significance value is indicative of a level of relevance of the attribute in contributing to correct classification of the group of defect candidates;
generate one or more second datasets based on the first dataset, wherein each second dataset comprises the group of defect candidates, each defect candidate associated with a synthetic label assigned to disrupt correlation between the defect candidate and the respective GT label thereof;
retrain the ML model respectively using the one or more second datasets, and estimate, for each attribute, one or more second significance values based on one or more respectively retrained ML models;
calculate a normalized significance value for each attribute based on the first significance value and the one or more second significance values of the attribute; and
select a subset of attributes from the set of attributes based on their respective normalized significance values.

2. The computerized system according to claim 1, wherein the processing circuitry is configured to train the ML model by: for each given defect candidate in the group, processing the given defect candidate by the ML model, to obtain a predicted class thereof, and optimizing the ML model using a loss function based on the predicted class and the GT label associated with the given defect candidate, and wherein the first significance value for each attribute is estimated based on a function or a rule of the trained ML model.

3. The computerized system according to claim 1, wherein the synthetic label for each defect candidate in a second dataset is randomly assigned in accordance with a probability predefined based on the number of classes of the defect candidates present in the first dataset, so as to result in substantially equivalent distribution of defect candidates associated with each synthetic label in the second dataset.

4. The computerized system according to claim 1, wherein the normalized significance value for each given attribute is calculated based on a ratio of the number of second significance values that exceed the first significance value for the given attribute, to a total number of the second significance values.

5. The computerized system according to claim 1, wherein the processing circuitry is further configured to, prior to generating the one or more second datasets: select a plurality of top-ranking attributes from the set of attributes based on the first significance values thereof, and perform the subsequent steps of generating, retraining, calculating, and selecting, with respect to the plurality of top-ranking attributes in place of the set of attributes, so as to improve computational efficiency.

6. The computerized system according to claim 1, wherein the normalized significance value of a given attribute represents statistical importance of the given attribute, with reduced bias compared to the first significance value of the given attribute.

7. The computerized system according to claim 1, wherein the set of attributes includes one or more hand-crafted attributes from a group comprising: grade, volume, polarity, strength, size, location, and probability of the defect candidate being a defect of interest.

8. The computerized system according to claim 1, wherein the set of attributes includes one or more abstract attributes extracted from a neural network used to pre-process the group of defect candidates.

9. The computerized system according to claim 1, wherein the selected subset of attributes is usable for characterizing a training set of defect candidates usable for training a classifier for defect classification.

10. The computerized system according to claim 1, wherein the selected subset of attributes is usable for clustering or ranking of defect candidates.

11. A computerized method of attribute selection, the method comprising:
obtaining a first dataset comprising a group of defect candidates resulting from examining a semiconductor specimen, each defect candidate characterized by a set of attributes and associated with a respective ground truth (GT) label indicative of a class thereof;
training a machine learning (ML) model using the first dataset, and estimating, for each attribute in the set of attributes, a first significance value based on the trained ML model, wherein the first significance value is indicative of a level of relevance of the attribute in contributing to correct classification of the group of defect candidates;
generating one or more second datasets based on the first dataset, wherein each second dataset comprises the group of defect candidates, each defect candidate associated with a synthetic label assigned to disrupt correlation between the defect candidate and the respective GT label thereof;
retraining the ML model respectively using the one or more second datasets, and estimating, for each attribute, one or more second significance values based on one or more respectively retrained ML models;
calculating a normalized significance value for each attribute based on the first significance value and the one or more second significance values of the attribute; and
selecting a subset of attributes from the set of attributes based on their respective normalized significance values.

12. The computerized method according to claim 11, wherein the training of the ML model comprises: for each given defect candidate in the group, processing the given defect candidate by the ML model, to obtain a predicted class thereof, and optimizing the ML model using a loss function based on the predicted class and the GT label associated with the given defect candidate, and wherein the first significance value for each attribute is estimated based on a function or a rule of the trained ML model.

13. The computerized method according to claim 11, wherein the synthetic label for each defect candidate in a second dataset is randomly assigned in accordance with a probability predefined based on the number of classes of the defect candidates present in the first dataset, so as to result in substantially equivalent distribution of defect candidates associated with each synthetic label in the second dataset.

14. The computerized method according to claim 11, wherein the normalized significance value for each given attribute is calculated based on a ratio of the number of second significance values that exceed the first significance value for the given attribute, to a total number of the second significance values.

15. The computerized method according to claim 11, further comprising, prior to generating the one or more second datasets: selecting a plurality of top-ranking attributes from the set of attributes based on the first significance values thereof, and performing the subsequent steps of generating, retraining, calculating, and selecting, with respect to the plurality of top-ranking attributes in place of the set of attributes, so as to improve computational efficiency.

16. The computerized method according to claim 11, wherein the normalized significance value of a given attribute represents statistical importance of the given attribute, with reduced bias compared to the first significance value of the given attribute.

17. The computerized method according to claim 11, wherein the set of attributes comprises one or more hand-crafted attributes from a group comprising: grade, volume, polarity, strength, size, location, and probability of the defect candidate being a defect of interest.

18. The computerized method according to claim 11, wherein the set of attributes comprises one or more abstract attributes extracted from a neural network used to pre-process the group of defect candidates.

19. The computerized method according to claim 11, wherein the selected subset of attributes is usable for characterizing a training set of defect candidates usable for training a classifier for defect classification.

20. A non-transitory computer readable storage medium tangibly embodying a program of instructions that, when executed by a computer, cause the computer to perform a method of attribute selection, the method comprising:
obtaining a first dataset comprising a group of defect candidates resulting from examining a semiconductor specimen, each defect candidate characterized by a set of attributes and associated with a respective ground truth (GT) label indicative of a class thereof;
training a machine learning (ML) model using the first dataset, and estimating, for each attribute in the set of attributes, a first significance value based on the trained ML model, wherein the first significance value is indicative of a level of relevance of the attribute in contributing to correct classification of the group of defect candidates;
generating one or more second datasets based on the first dataset, wherein each second dataset comprises the group of defect candidates, each defect candidate associated with a synthetic label assigned to disrupt correlation between the defect candidate and the respective GT label thereof;
retraining the ML model respectively using the one or more second datasets, and estimating, for each attribute, one or more second significance values based on one or more respectively retrained ML models;
calculating a normalized significance value for each attribute based on the first significance value and the one or more second significance values of the attribute; and
selecting a subset of attributes from the set of attributes based on their respective normalized significance values.
